(19) United States
(12) Patent Application Publication
(10) Pub. No.: US 2025/0117995 A1
(43) Pub. Date: Apr. 10, 2025

(54) IMAGE AND DEPTH MAP GENERATION USING A CONDITIONAL MACHINE LEARNING

(71) Applicant: ADOBE INC., SAN JOSE, CA (US)

(72) Inventors: Yijun Li, Seattle, WA (US); Matheus Abrantes Gadelha, San Jose, CA (US); Krishna Kumar Singh, San Jose, CA (US); Soren Pirk, Palo Alto, CA (US)

(21) Appl. No.: 18/481,719

(22) Filed: Oct. 5, 2023

(51) Int. Cl. G06T 11/60; G06T 5/00; G06T 7/50; G06V 10/26

(52) U.S. Cl. CPC G06T 11/60; G06T 5/77; G06T 7/50; G06V 10/26; G06T 2207/20081

(57) ABSTRACT

Methods, non-transitory computer readable media, apparatuses, and systems for image and depth map generation include receiving a prompt and encoding the prompt to obtain a guidance embedding. A machine learning model then generates an image and a depth map corresponding to the image based on the guidance embedding. The image and the depth map are each generated based on the guidance embedding.

### BACKGROUND

The following relates generally to image generation, and more specifically to image generation using machine learning. An image can include one or more pixels (picture elements), where each pixel includes an intensity or gray level. Images can be generated and processed using various machine learning techniques. Machine learning is an information processing field in which algorithms or models such as artificial neural networks are trained to make predictive outputs in response to input data without being specifically programmed to do so. For example, a machine learning model can be trained to predict an output image using image training data.

### SUMMARY

Aspects of the present disclosure provide methods, non-transitory computer readable media, apparatuses, and systems for generating an image and a depth map using a machine learning model based on a prompt. According to an aspect of the present disclosure, an image generation system embeds a prompt to obtain guidance features and uses an image generation machine learning model to generate both an image and a depth map for the image, where the image generation machine learning model is guided by the guidance features.

In some cases, the depth map includes depth information for the image. In some cases, by simultaneously generating the image and the depth map (e.g., by learning a joint distribution of color information and depth information), the image generation machine learning model causes the image and the depth map to describe a same scene and be spatially pixel-aligned with each other. In some cases, because the depth map is generated using the image generation machine learning model, the image generation system avoids a use of a separate depth map generation algorithm or model, which is inefficient and time-consuming.

Furthermore, in some cases, by generating the image and the depth map based on the prompt, the image generation system allows a user to have a higher degree of control over content of the image and the depth map than conventional image generation systems that provide color information and depth information for an image.

A method, apparatus, non-transitory computer readable medium, and system for image generation using machine learning are described. One or more aspects of the method, apparatus, non-transitory computer readable medium, and system include receiving a prompt; encoding, using an encoder, the prompt to obtain a guidance embedding; and generating, using an image generation model, an image and a depth map corresponding to the image based on the guidance embedding.

A method, apparatus, non-transitory computer readable medium, and system for image generation using machine learning are described. One or more aspects of the method, apparatus, non-transitory computer readable medium, and system include initializing an image generation model; obtaining training data including a prompt, a ground-truth image, and a ground-truth depth map; and training, using the training data, the image generation model to generate an image and a depth map based on the prompt.

An apparatus and system for image generation using machine learning are described. One or more aspects of the apparatus and system include one or more processors; one or more memory components coupled with the one or more processors; and an image generation model comprising parameters stored in the one or more memory components and trained to generate an image and a depth map for the image based on a text prompt.

### BRIEF DESCRIPTION OF THE DRAWINGS

FIG. 1 shows an example of an image generation system according to aspects of the present disclosure.

FIG. 2 shows an example of a method for generating a series of images according to aspects of the present disclosure.

FIG. 3 shows an example of sets of generated images and corresponding depth maps according to aspects of the present disclosure.

FIG. 4 shows an example of sets of modified images and corresponding modified depth maps according to aspects of the present disclosure.

FIG. 5 shows an example of an image generation apparatus according to aspects of the present disclosure.

FIG. 6 shows an example of a guided diffusion architecture according to aspects of the present disclosure.

FIG. 7 shows an example of a U-NET according to aspects of the present disclosure.

FIG. 8 shows an example of a method for generating an image and a depth map according to aspects of the present disclosure.

FIG. 9 shows an example of diffusion processes according to aspects of the present disclosure.

FIG. 10 shows an example of generating an image and a depth map according to aspects of the present disclosure.

FIG. 11 shows an example of a method for generating a modified image according to aspects of the present disclosure.

FIG. 12 shows an example of generating a modified image according to aspects of the present disclosure.

FIG. 13 shows an example of a method for training an image generation model according to aspects of the present disclosure.

FIG. 14 shows an example of a method for training a diffusion model according to aspects of the present disclosure.

FIG. 15 shows an example of a method for training an image generation model to perform inpainting according to aspects of the present disclosure.

FIG. 16 shows an example of an occlusion mask obtained by applying a mask to random pixels of a ground-truth image according to aspects of the present disclosure.

FIG. 17 shows an example of an occlusion mask obtained by shifting a camera view of a ground-truth image according to aspects of the present disclosure.

FIG. 18 shows an example of training an image generation model to perform inpainting according to aspects of the present disclosure.

FIG. 19 shows an example of a computing device according to aspects of the present disclosure.

### DETAILED DESCRIPTION

The present disclosure relates to image generation using machine learning. An image can include one or more pixels (picture elements), where each pixel includes a pixel value having an intensity or gray level. An image can include one or more image channels, where each image channel can be represented as a grayscale image and includes an array of pixel values. Both color information and depth information (e.g., information relating to distances of surfaces from a viewpoint) of an image can be included in image channels of the image.

Both color information and depth information (such as a depth map) for an image can be generated using a machine learning model. When the color information and the depth information are generated with each other, the machine learning model causes the color information and the depth information to describe a same scene and be spatially pixel-aligned with each other.

An example of a conventional image generation system generates color information and depth information for an image using an unconditional machine learning model. However, an unconditional machine learning model generates a new image without any specific input, but instead generates an image based on a distribution of training data for the unconditional machine learning model. It is therefore difficult and inconvenient to obtain a specific output using an unconditional machine learning model.

Furthermore, depth information is useful for downstream image processing tasks, such as generating a series of images that consistently depict an object within a three-dimensional space. An example of a conventional image generation system first uses an unconditional machine learning model to generate color information and depth information for a first image and then uses a separate machine learning model to inpaint a second image based on the color information and the depth information, such that the second image depicts an object from the first image from a different viewpoint. However, using two separate machine learning models to respectively perform initial image generation and image inpainting is costly and time-consuming. Additionally, a photorealism and consistency between the first image and the second image is decreased because the two separate machine learning models are separately trained using separate training data.

Aspects of the present disclosure provide methods, non-transitory computer readable media, apparatuses, and systems for generating an image and a depth map using a machine learning model based on a prompt. According to an aspect of the present disclosure, an image generation system embeds a prompt to obtain guidance features and uses an image generation machine learning model to generate both an image and a depth map for the image, where the image generation machine learning model is guided by the guidance features.

In some cases, by generating the image and the depth map based on the prompt, the image generation system allows a user to have a higher degree of control over content of the image and the depth map than a conventional image generation system that uses an unconditional machine learning model.

Furthermore, according to some aspects, the image generation system identifies an occlusion area for a modified view of the image based on the image and the depth map and uses the image generation machine learning model to generate a modified image by inpainting the occlusion area. Accordingly, in some cases, because the modified image is generated based on the image and the depth map, the image generation system provides an image and a modified image that both depict a similar object in a three-dimensionally consistent manner. Additionally, by using the same image generation machine learning model to generate the image and to inpaint the modified image, the image generation system avoids a time and expense incurred by the conventional image generation system that uses separate image generation and image inpainting machine learning models.

An aspect of the present disclosure is used in an image generation context. For example, a user of the image generation system provides a text prompt “A cute puppy” to the image generation system via a user interface. The image generation system encodes the text prompt to obtain guidance features for an image generation model. The image generation system uses the image generation model to generate an image of a cute puppy and a corresponding depth map including depth information for the image according to an image generation process (such as a reverse diffusion process) that is guided by the guidance features.

In the example, the image generation system computes a camera view of the image and of the depth map, and shifts the camera view to obtain a modified view for an occluded image and an occluded depth map. Each of the occluded image and the occluded depth map include “missing” pixels lacking information caused by occlusion from the modified view. The image generation system uses the image generation model to generate a modified image and a modified depth map including an alternative view of the cute puppy depicted in the image by inpainting the missing pixels of the occluded image and the occluded depth map. Because the modified image and the modified depth map are simultaneously generated, a consistency between the modified image and the modified depth map and a three-dimensional consistency of the cute puppy depicted in the image and the modified image is increased.

In the example, the image generation system iteratively generates additional modified images and modified depth maps using a similar process. In the example, by performing successive inpainting, a set of images including the image, the modified image, and the additional modified images depict the cute puppy from multiple different viewpoints. The image generation system creates a video file from the image, the modified image, and the additional modified images, where each of the images is a frame of a video included in the video file, and provides the video file to the user. Due to the multiple viewpoints, the video appears to show a perspective of a camera that moves around a consistent cute puppy in a three-dimensional space.

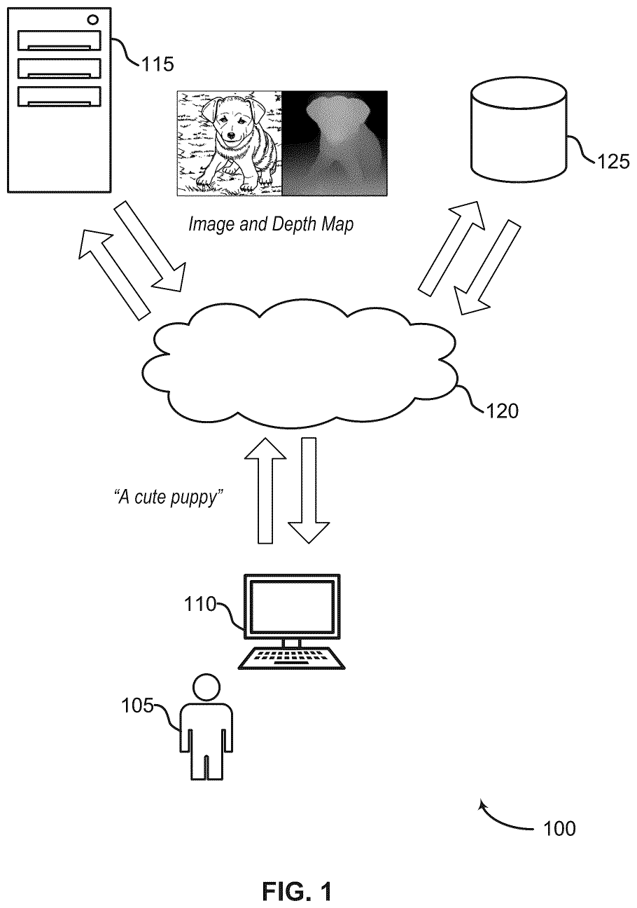

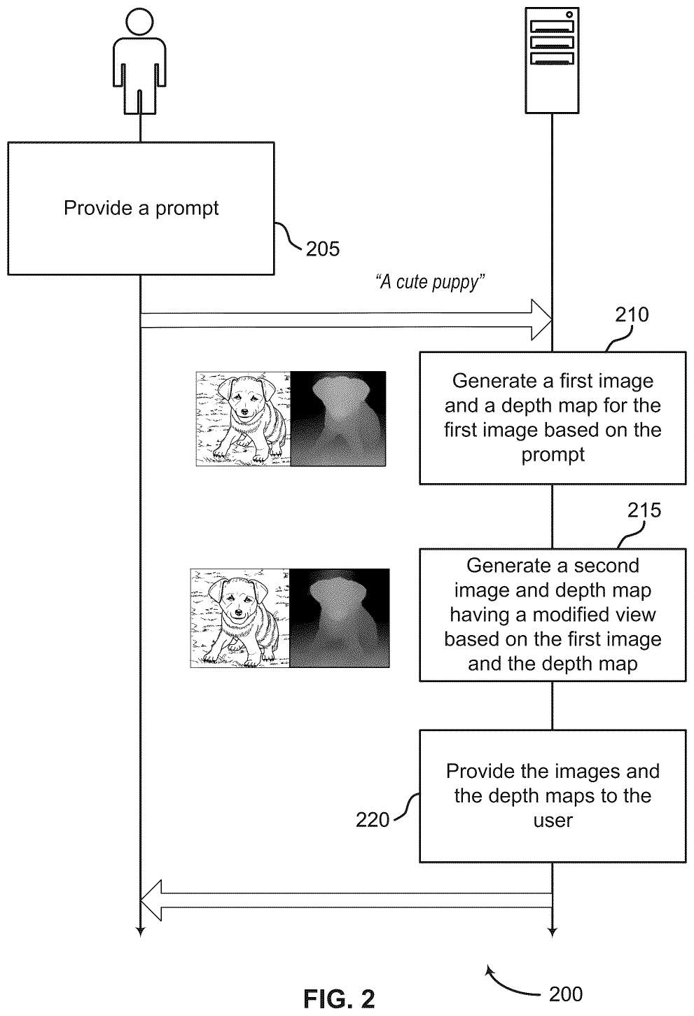

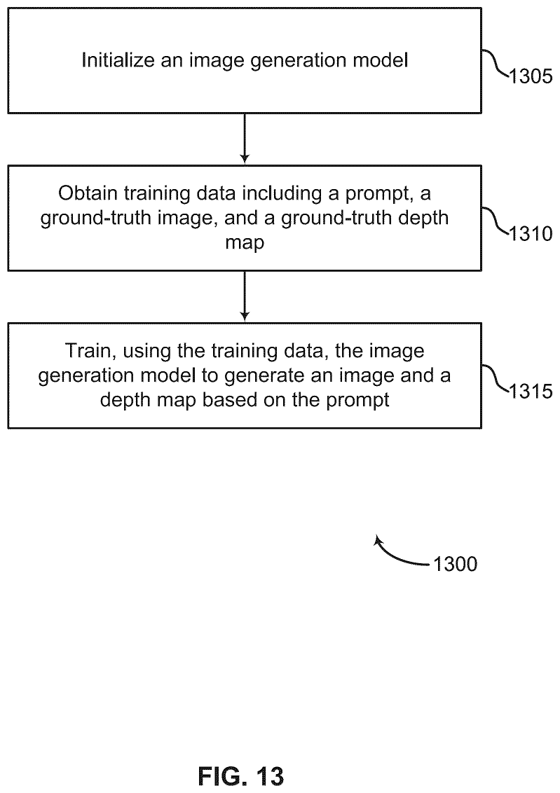

Further example applications of the present disclosure in the image generation context are provided with reference to FIGS. 1-4. Details regarding the architecture of the image generation system are provided with reference to FIGS. 1, 5-7, and 19. Examples of a process for image generation are provided with reference to FIGS. 2 and 8-12. Examples of a process for training an image generation model are provided with reference to FIGS. 13-18.

According to some aspects, an image generation system generates an image and a depth map using a prompt-conditioned image generation model. By using a prompt-conditioned image generation model to generate the image and the depth map, the image generation system provides color and depth information for an image in an efficient and user-customizable manner.

Furthermore, according to some aspects, the image generation system uses the image generation model to generate a modified image based on the image and the depth map, where the modified image depicts an object depicted in the image from a modified viewpoint. By generating the modified image based on the image and the depth map, a three-dimensional consistency of the object between the image and the modified image is increased. Additionally, by generating the image and the modified image using a same image generation model, rather than separate generation and inpainting models, the three-dimensional consistency of the object is further increased, and the time, expense, and inefficiencies associated with using the separate generation and inpainting models is avoided.

### Image Generation System

A system and an apparatus for image generation using machine learning is described with reference to FIGS. 1-7 and 19. One or more aspects of the system and the apparatus include one or more processors; one or more memory components coupled with the one or more processors; and an image generation model comprising parameters stored in the one or more memory components and trained to generate an image and a depth map for the image based on a text prompt. In some aspects, the image generation model comprises a diffusion model.

Some examples of the system and the apparatus further include an occlusion component configured to generate an occlusion area for a modified view of the image based on the image and the depth map. In some aspects, the image generation model is further trained to generate a modified image by inpainting the occlusion area.

Some examples of the system and the apparatus further include an encoder configured to generate a guidance embedding based on the prompt. Some examples of the system and the apparatus further include a training component configured to train the image generation model.

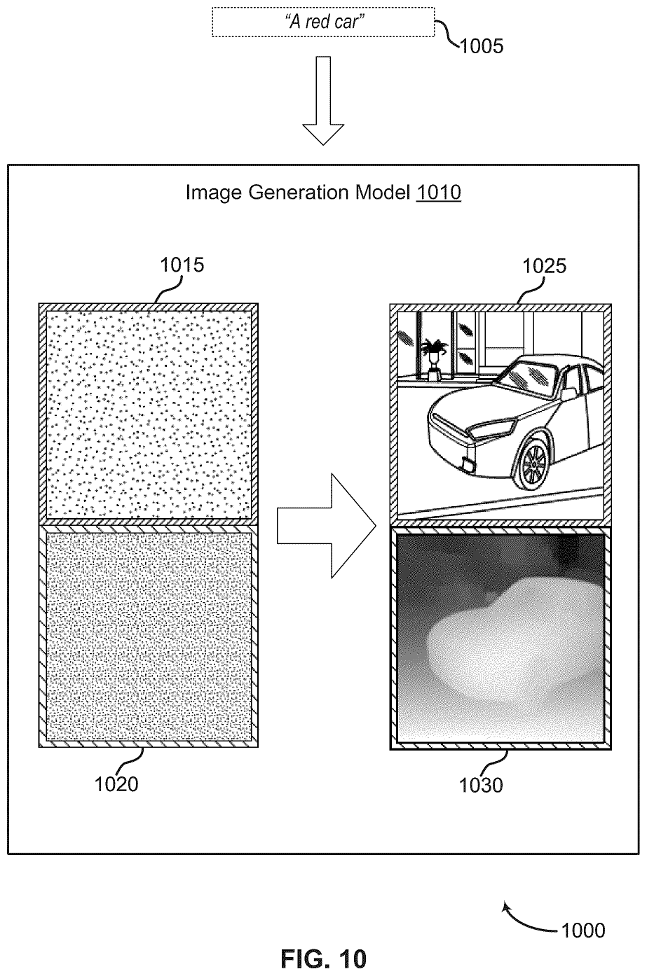

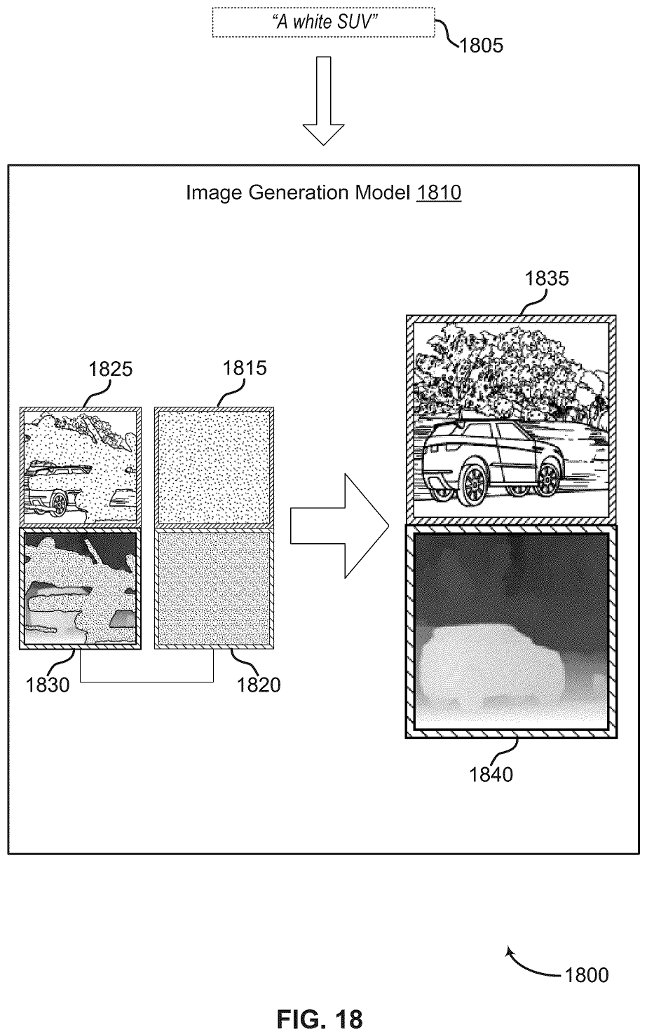

FIG. 1 shows an example of an image generation system 100 according to aspects of the present disclosure. The example shown includes user 105, user device 110, image generation apparatus 115, cloud 120, and database 125. Image generation system 100 is an example of, or includes aspects of, the corresponding element described with reference to FIGS. 10 and 18.

Referring to FIG. 1, according to some aspects, user 105 provides a prompt (e.g., a text prompt such as “A cute puppy”) to image generation apparatus 115 via user device 110. In some cases, image generation apparatus 115 provides a user interface on user device 110, and user 105 provides the prompt via the user interface.

According to some aspects, image generation apparatus 115 generates an image and a depth map using an image generation model conditioned on the prompt. As shown in FIG. 1, the image depicts a cute puppy, and the depth map is a visual representation of depth information for the image. According to some aspects, image generation apparatus 115 provides the image and depth map to user 105 via the user interface.

According to some aspects, image generation apparatus 115 uses the image generation model to generate a modified image based on the image and the depth map by inpainting an occlusion area for a modified view of the image, such that the modified image depicts the cute puppy from a different viewpoint. According to some aspects, image generation apparatus 115 provides the modified image to user 105 via the user interface. In some cases, image generation apparatus 115 includes the image and the modified image as frames in a video and provides a video file including the video to user 105 via the user interface.

As used herein, a “prompt” refers to information that is used to inform an intended output of a machine learning model, such that the output depicts content described by the prompt. In some cases, a prompt includes text, an image, or information in another modality (such as audio) that is capable of describing content of the output.

As used herein, a “guidance embedding” or “guidance features” refers to a mathematical representation of the prompt in a lower-dimensional space such that the information about the intended output of the machine learning is more easily captured and analyzed by the machine learning model. For example, in some cases, a guidance embedding is a numerical representation of the prompt in a continuous vector space (e.g., a guidance space) in which objects that have similar semantic information correspond to vectors that are numerically similar to and thus “closer” to each other, providing for an ability of the machine learning model to effectively compare different objects corresponding to different embeddings with each other.

In some cases, the guidance embedding is produced in a modality (such as a text modality, an image modality, an audio modality, etc.) that corresponds to a modality of the prompt. In some cases, the guidance embedding is generated or translated into a multimodal embedding space, such that objects from multiple modalities (e.g., a text modality and an image modality) can be effectively compared with each other.

As used herein, an “image generation model” refers to a machine learning model configured, designed, and/or trained to generate an image. In some cases, the image generation model is a diffusion model. In some cases, the image generation model is a conditional image generation model, such that an output of the image generation model is guided by or conditioned on the guidance embedding. By contrast, an unconditional machine learning model is not specifically guided, but rather produces an output based solely on a learned distribution of a training data set.

As used herein, in some cases, an “image” refers to a visual representation of pixel values corresponding to color information. In some cases, an image comprises one or more image channels. In some cases, each image channel is a representation of one aspect of visual information of the image (such as a primary color for each pixel of the image or depth information for each pixel of the image). In some cases, an image comprises a red channel, a blue channel, and a green channel, where each image channel can be represented as a grayscale image including pixel values for the respective image channel colors.

As used herein, in some cases, a “depth map” refers to an image channel (that can be represented as a grayscale image) including depth information for each pixel of the image, where depth information corresponds to a distance between a surface of an object depicted in the image from a viewpoint of the image.

As used herein, an “occlusion area” refers to one or more “missing” pixels of an image or a depth map that do not include pixel values. In some cases, for example, an occlusion area can be obtained by shifting a camera view of an image to obtain a modified view of the image, where the occlusion area includes pixels that “should” be visible in the modified view but lack pixel values because they were occluded in the original image.

According to some aspects, user device 110 is a personal computer, laptop computer, mainframe computer, palmtop computer, personal assistant, mobile device, or any other suitable processing apparatus. In some examples, user device 110 includes software that displays the user interface (e.g., a graphical user interface) provided by image generation apparatus 115. In some aspects, the user interface allows information (such as an image, a prompt, user inputs, etc.) to be communicated between user 105 and image generation apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

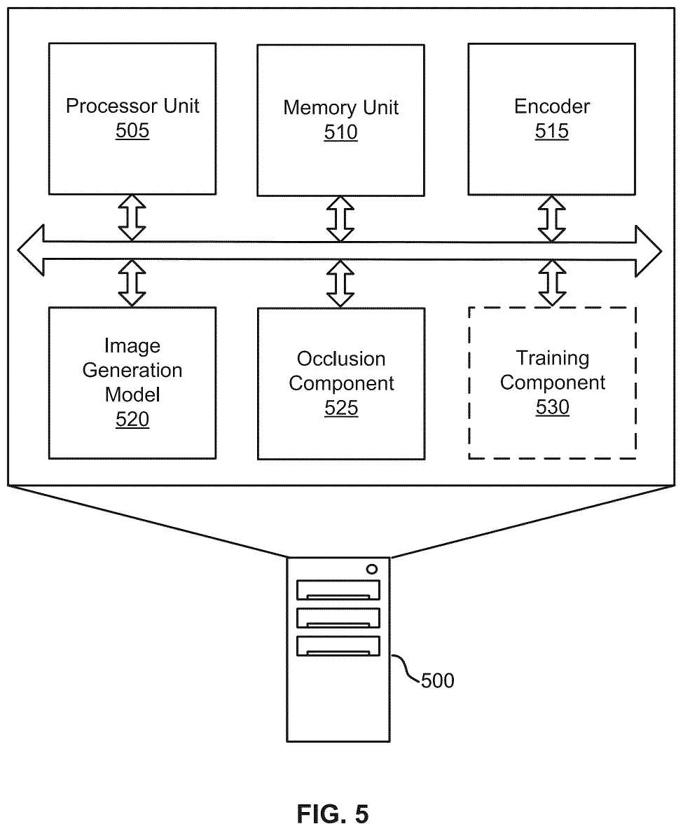

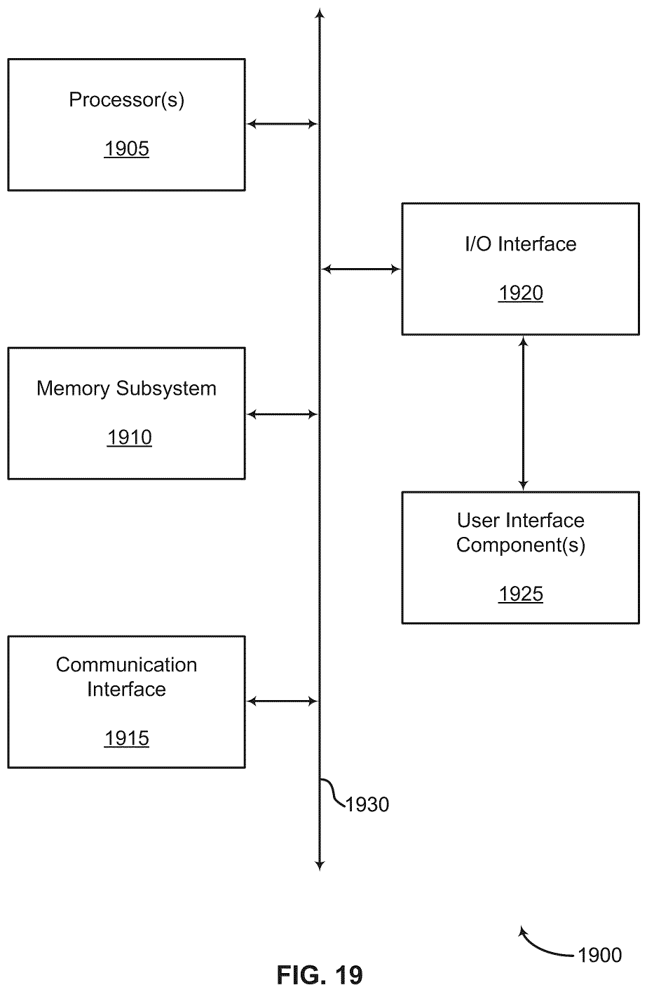

Image generation apparatus 115 is an example of, or includes aspects of, the corresponding element described with reference to FIGS. 5 and 19. According to some aspects, image generation apparatus 115 includes a computer-implemented network. In some embodiments, the computer-implemented network includes a machine learning model (such as the image generation model described with reference to FIGS. 5, 10, and 18). In some embodiments, image generation apparatus 115 also includes one or more processors, a memory subsystem, a communication interface, an I/O interface, one or more user interface components, and a bus as described with reference to FIG. 19. Additionally, in some embodiments, image generation apparatus 115 communicates with user device 110 and database 125 via cloud 120.

In some cases, image generation apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of image generation apparatus 115 is provided with reference to FIGS. 5-7 and 19. Further detail regarding a process for image generation is provided with reference to FIGS. 2-4 and 8-12. Examples of a process for training an image generation model are provided with reference to FIGS. 13-18.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some cases, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, image generation apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image generation apparatus 115 and communicates with image generation apparatus 115 via cloud 120. According to some aspects, database 125 is included in image generation apparatus 115.

FIG. 2 shows an example of a method 200 for generating a series of images according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, an image generation system according to some aspects of the present disclosure generates a series of consistent views of a scene described in a text prompt. For example, in some cases, the image generation system generates an image and a depth map for the image using an image generation model conditioned on the text prompt, where the image depicts content described by the text prompt and the depth map includes relative distance information for surfaces of objects depicted in the image.

In some cases, the image generation system generates a modified image based on the image and the depth map, where the modified image depicts an object depicted in the image from a modified viewpoint. In some cases, the image generation model is able to use the depth map to achieve a consistency of representation of the object between the image and the modified image that is not provided by conventional image generation systems. Accordingly, in some cases, the image generation system provides generated images under different views that simulate a moving path of a camera in a three-dimensionally consistent and photorealistic manner.

At operation 205, a user provides a prompt. In some cases, the operations of this step refer to, or may be performed by, a user as described with reference to FIG. 1. For example, in some cases, the prompt is a text prompt (e.g., “A cute puppy”). In some cases, the user provides the prompt via a user interface provided on a user device (such as the user device described with reference to FIG. 1) by the image generation system.

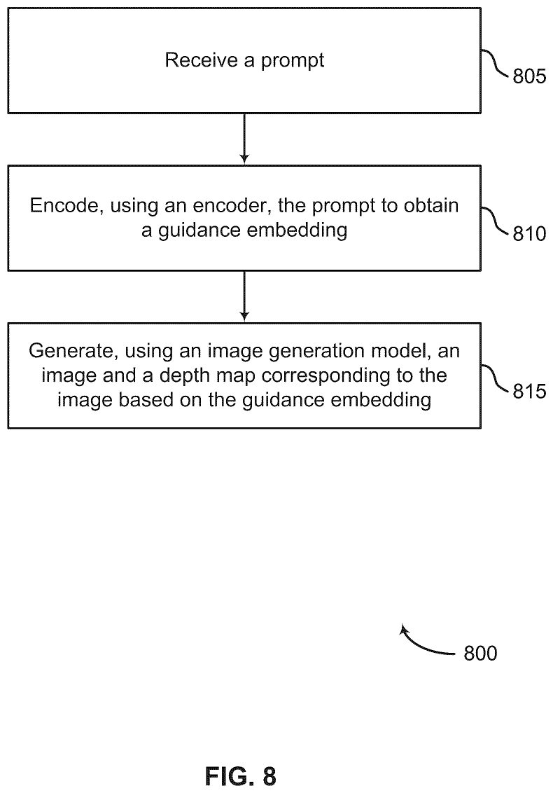

At operation 210, the system generates a first image and a depth map for the first image based on the prompt. In some cases, the operations of this step refer to, or may be performed by, an image generation apparatus as described with reference to FIGS. 1 and 5. For example, in some cases, the image generation apparatus generates an image and a depth map based on a prompt as described with reference to FIGS. 8-10.

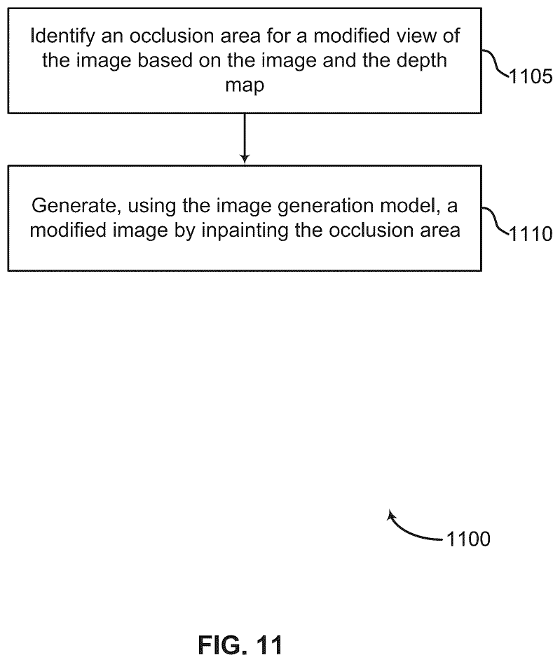

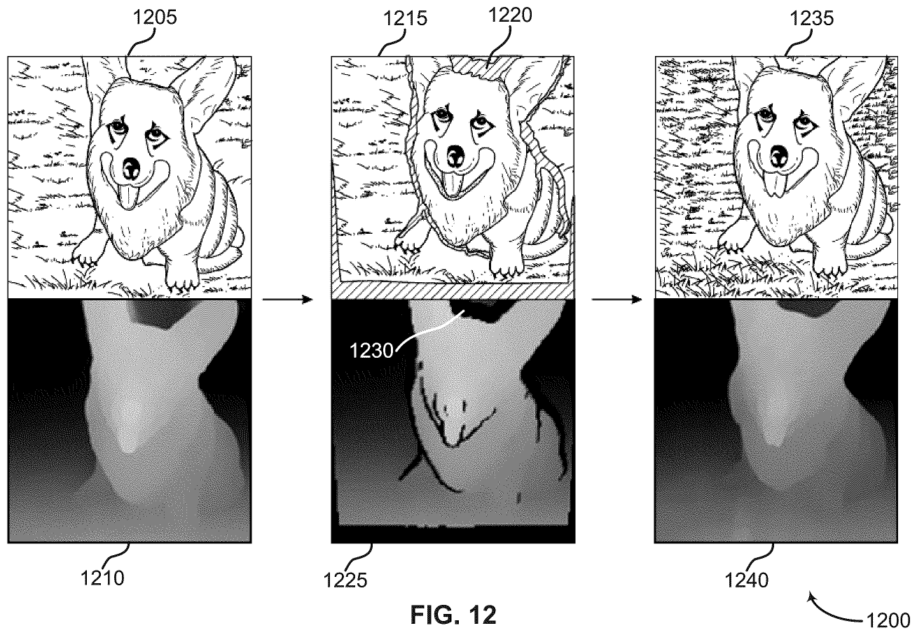

At operation 215, the system generates a second image having a modified view based on the first image and the depth map. In some cases, the operations of this step refer to, or may be performed by, an image generation apparatus as described with reference to FIGS. 1 and 5. For example, in some cases, the image generation apparatus generates a modified image and a modified depth map based on an image and a depth map as described with reference to FIGS. 11-12.

At operation 220, the system provides the first image and the second image to the user. In some cases, the operations of this step refer to, or may be performed by, an image generation apparatus as described with reference to FIGS. 1 and 5.

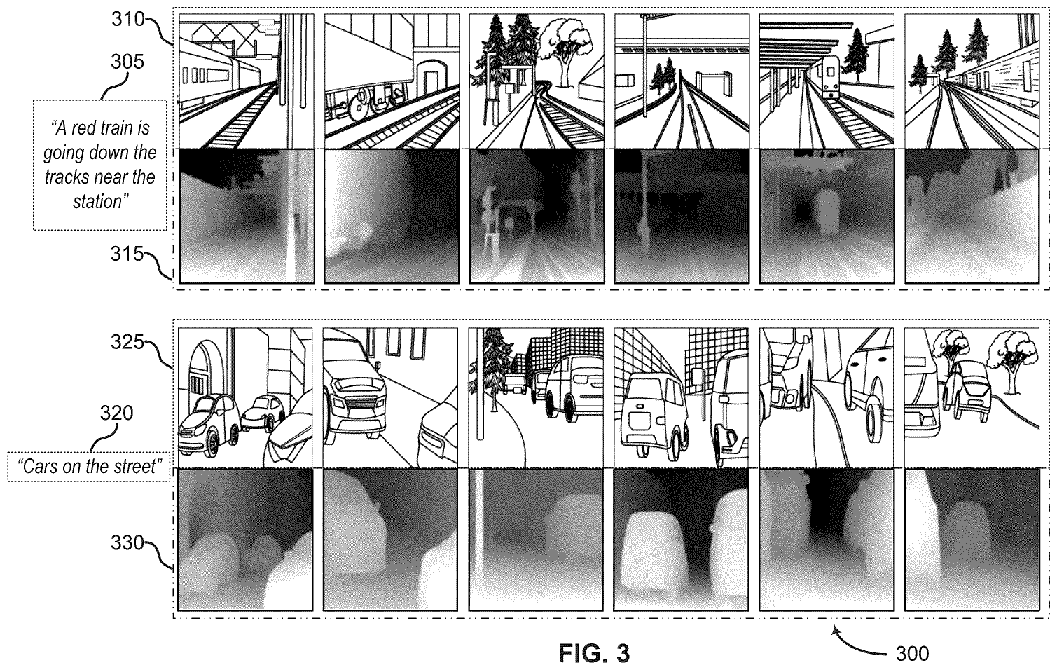

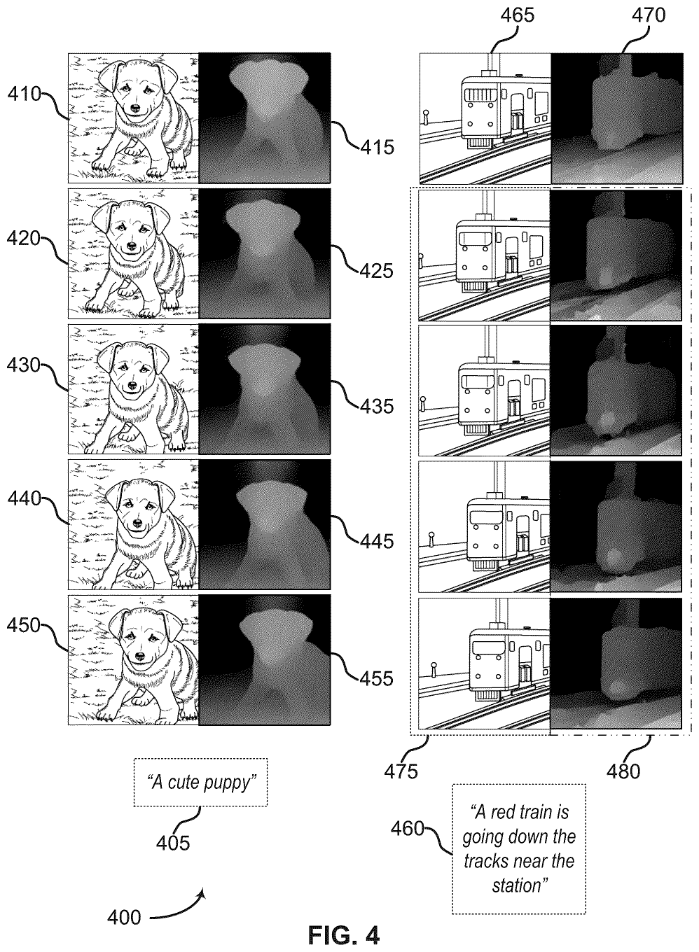

FIG. 3 shows an example 300 of sets of generated images and corresponding depth maps according to aspects of the present disclosure. The example shown includes first prompt 305, first set of images 310, first set of depth maps 315, second prompt 320, second set of images 325, and second set of depth maps 330. First set of images 310 and second set of images 325 include images that are examples of, or include aspects of, images described with reference to FIGS. 4, 10, 12, and 18. First set of depth maps 315 and second set of depth maps 330 include depth maps that are examples of, or include aspects of, depth maps described with reference to FIGS. 4, 10, 12, and 18.

Referring to FIG. 3, according to some aspects, an image generation system (such as the image generation system described with reference to FIGS. 1, 10, and 18) generates an image and a depth map for the image using a prompt-conditioned image generation model (such as the image generation model described with reference to FIGS. 5, 10, and 18). As shown in example 300, first set of images 310 and first set of depth maps 315 include images and depth maps generated based on first prompt 305 (“A red train is going down the tracks near the station”), and second set of images 325 and second set of depth maps 330 include images and depth maps generated based on second prompt 320 (“Cars on the street”). In some cases, an image is a visual representation of color information, and a depth map is a visual representation of depth information for the image.

FIG. 4 shows an example 400 of sets of modified images and corresponding depth maps according to aspects of the present disclosure. The example shown includes first prompt 405, first image 410, first depth map 415, first modified image 420, first modified depth map 425, second modified image 430, second modified depth map 435, third modified image 440, third modified depth map 445, fourth modified image 450, fourth modified depth map 455, second prompt 460, second image 465, second depth map 470, set of modified images 475, and set of depth maps 480.

First image 410 and second image 465 are examples of, or include aspects of, images described with reference to FIGS. 3, 10, 12, and 18. First depth map 415 and second depth map 470 are examples of, or include aspects of, depth maps described with reference to FIGS. 3, 10, 12, and 18. First modified image 420 is an example of, or includes aspects, of, a modified image described with reference to FIG. 12. First modified depth map 425 is an example of, or includes aspects, of, a modified depth map described with reference to FIG. 12.

Referring to FIG. 4, according to some aspects, an image generation system (such as the image generation system described with reference to FIGS. 1, 10, and 18) generates an image and a depth map for the image using a prompt-conditioned image generation model (such as the image generation model described with reference to FIGS. 5, 10, and 18), and generates a set of modified images and a set of modified depth maps based on the image and the depth map for the image.

As shown in example 400, first image 410 and first depth map 415 are generated based on first prompt 405 (“A cute puppy”). First modified image 420 and first modified depth map 425 are generated based on first image 410 and first depth map 415, second modified image 430 and second modified depth map 435 are generated based on first modified image 420 and first modified depth map 425, third modified image 440 and third modified depth map 445 are generated based on second modified image 430 and second modified depth map 435, and fourth modified image 450 and fourth modified depth map 455 are generated based on third modified image 440 and third modified depth map 445.

As shown in FIG. 4, first modified image 420 through fourth modified image 450 show respectively modified views of a puppy illustrated in first image 410, where the puppy appears to be the same puppy in a same setting that is presented from successively different viewpoints.

Likewise, second image 465 and second depth map 470 are generated based on second prompt 460 (“A red train is going down the tracks near the station”), and set of modified images 475 and set of depth maps 480 are respectively and successively generated based on second image 465 and second depth map 470. As shown in FIG. 4, second image 465 and set of modified images 475 together show a visually similar red train in motion against a visually similar background.

FIG. 5 shows an example of an image generation apparatus according to aspects of the present disclosure. Image generation apparatus 500 is an example of, or includes aspects of, the corresponding element described with reference to FIG. 1. In one aspect, image generation apparatus 500 includes processor unit 505, memory unit 510, encoder 515, image generation model 520, occlusion component 525, and training component 530.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 505 is configured to operate a memory array using a memory controller. In other cases, a memory controller is integrated into processor unit 505. In some cases, processor unit 505 is configured to execute computer-readable instructions stored in memory unit 510 to perform various functions. In some aspects, processor unit 505 includes special purpose components for modem processing, baseband processing, digital signal processing, or transmission processing. According to some aspects, processor unit 505 comprises the one or more processors described with reference to FIG. 19.

Memory unit 510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

In some cases, memory unit 510 includes a basic input/output system (BIOS) that controls basic hardware or software operations, such as an interaction with peripheral components or devices. In some cases, memory unit 510 includes a memory controller that operates memory cells of memory unit 510. For example, the memory controller may include a row decoder, column decoder, or both. In some cases, memory cells within memory unit 510 store information in the form of a logical state. According to some aspects, memory unit 510 comprises the memory subsystem described with reference to FIG. 19.

According to some aspects, image generation apparatus 500 uses at least one processor included in processor unit 505 to execute instructions stored in at least one memory device included in memory unit 510 to perform operations. For example, according to some aspects, image generation apparatus 500 receives a prompt. In some aspects, the prompt includes a text prompt. In some examples, image generation apparatus 500 generates a video file based on an image and a modified image.

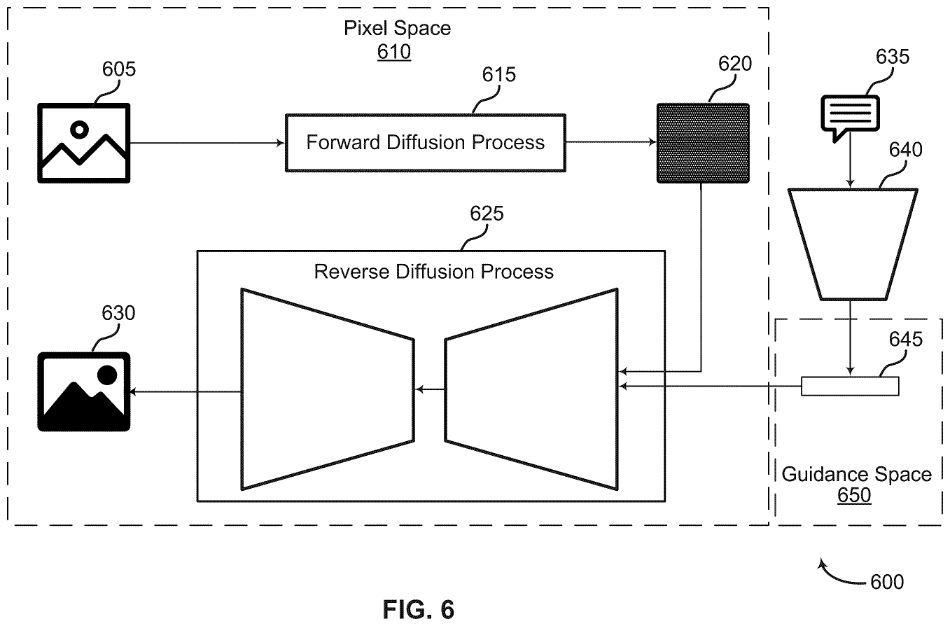

Encoder 515 is an example of, or includes aspects of, the corresponding element described with reference to FIG. 6. According to some aspects, encoder 515 is implemented as software stored in memory unit 510 and executable by processor unit 505, as firmware, as one or more hardware circuits, or as a combination thereof. According to some aspects, encoder 515 comprises encoder parameters (e.g., machine learning parameters) stored in memory unit 510.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, that control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, encoder 515 comprises one or more ANNs configured to generate a guidance embedding based on the prompt. In some cases, encoder 515 includes a text encoder. In some cases, the text encoder comprises a recurrent neural network (RNN), a transformer, or other ANN suitable for encoding textual information.

A recurrent neural network (RNN) is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

In some cases, a transformer comprises one or more ANNs comprising attention mechanisms that enable the transformer to weigh an importance of different words or tokens within a sequence. In some cases, a transformer processes entire sequences simultaneously in parallel, making the transformer highly efficient and allowing the transformer to capture long-range dependencies more effectively.

In some cases, a transformer comprises an encoder-decoder structure. In some cases, the encoder of the transformer processes an input sequence and encodes the input sequence into a set of high-dimensional representations. In some cases, the decoder of the transformer generates an output sequence based on the encoded representations and previously generated tokens. In some cases, the encoder and the decoder are composed of multiple layers of self-attention mechanisms and feed-forward ANNs.

In some cases, the self-attention mechanism allows the transformer to focus on different parts of an input sequence while computing representations for the input sequence. In some cases, the self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in natural language processing (NLP) and sequence-to-sequence tasks, that allows an ANN to focus on different parts of an input sequence when making predictions or generating output.

NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. In some cases, these models express the relative probability of multiple answers.

Some sequence models (such as recurrent neural networks) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

In some cases, an ANN employing an attention mechanism receives an input sequence and maintains its current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

In some cases, by incorporating an attention mechanism, an ANN dynamically allocates attention to different parts of the input sequence, allowing the ANN to focus on relevant information and capture dependencies across longer distances.

In some cases, calculating attention involves three basic steps. First, a similarity between a query vector Q and a key vector K obtained from the input is computed to generate attention weights. In some cases, similarity functions used for this process include dot product, splice, detector, and the like. Next, a softmax function is used to normalize the attention weights. Finally, the attention weights are weighed together with their corresponding values V. In the context of an attention network, the key K and value V are typically vectors or matrices that are used to represent the input data. The key K is used to determine which parts of the input the attention mechanism should focus on, while the value V is used to represent the actual data being processed.

In some cases, encoder 515 includes an image encoder trained for encoding visual information, such as a convolutional neural network (CNN). A CNN is a class of ANN that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that they activate when they detect a particular feature within the input.

According to some aspects, encoder 515 includes a multimodal encoder trained to process and represent information from multiple modalities, such as text, images, audio, or other types of data, in a multimodal embedding space. In some cases, the multimodal encoder combines information from different modalities into a unified representation that can be further used for downstream tasks like classification, generation, or retrieval.

Image generation model 520 is an example of, or includes aspects of, the corresponding element described with reference to FIGS. 10 and 18. According to some aspects, image generation model 520 comprises parameters (e.g., machine learning parameters) stored in memory unit 510. According to some aspects, image generation model 520 comprises one or more ANNs trained to generate an image and a depth map for the image based on the prompt. According to some aspects, image generation model 520 is trained to generate an image and a depth map corresponding to the image based on the guidance embedding. In some aspects, the image generation model 520 is trained to generate a modified image by inpainting the occlusion area.

In some examples, image generation model 520 is trained to generate an additional modified image based on the modified image. In some examples, image generation model 520 is trained to average pixel information of the image and the modified image to obtain average pixel information, where the additional modified image is based on the average pixel information.

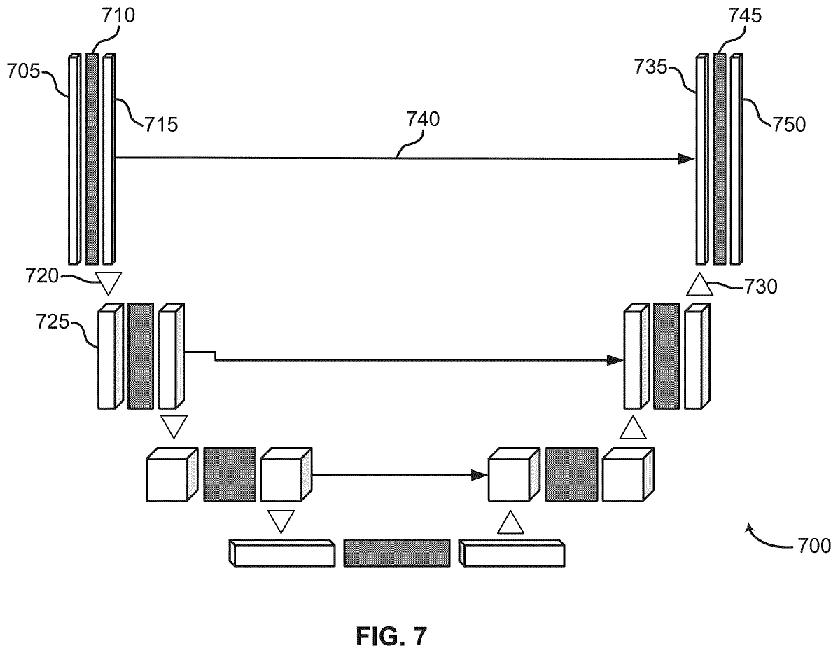

In some aspects, image generation model 520 includes a diffusion model (such as the diffusion model described with reference to FIG. 7). In some aspects, image generation model 520 includes a U-Net (such as the U-Net described with reference to FIG. 8).

According to some aspects, occlusion component 525 is implemented as software stored in memory unit 510 and executable by processor unit 505, as firmware, as one or more hardware circuits, or as a combination thereof. According to some aspects, occlusion component 525 identifies an occlusion area for a modified view of the image based on the image and the depth map. In some examples, occlusion component 525 computes a camera view of the image. In some examples, occlusion component 525 shifts the camera view to obtain the modified view.

According to some aspects, occlusion component 525 comprises one or more ANNs configured, designed, and/or trained to compute a camera view of the image and to shift the camera view to obtain the modified view. In some cases, occlusion component 525 comprises occlusion parameters (e.g., machine learning parameters) stored in memory unit 510.

For example, in some cases, occlusion component 525 comprises a regression ANN trained to convert each pixel coordinate of an image and a depth map into a three-dimensional point in a camera coordinate system. In some cases, the regression network is trained to convert the image and the depth map into respective three-dimensional triangular meshes, where a pixel of the image and the depth map respectively correspond to a vertex of the meshes. In some cases, occlusion component 525 uses the three-dimensional triangular meshes to render the modified view.

According to some aspects, training component 530 is implemented as software stored in memory unit 510 and executable by processor unit 505, as firmware, as one or more hardware circuits, or as a combination thereof. According to some aspects, training component 530 is omitted from image generation apparatus 500 and is implemented in at least one apparatus separate from image generation apparatus 500 (for example, at least one apparatus comprised in a cloud, such as the cloud described with reference to FIG. 1). According to some aspects, the separate apparatus comprising training component 530 communicates with image generation apparatus 500 (for example, via the cloud) to perform the functions of training component 530 described herein.

According to some aspects, training component 530 initializes image generation model 520. In some examples, training component 530 obtains training data including a prompt, a ground-truth image, and a ground-truth depth map. In some examples, training component 530 trains, using the training data, image generation model 520 to generate an image and a depth map based on the prompt.

In some examples, training component 530 computes an image loss based on the ground-truth image, where image generation model 520 is trained based on the image loss. In some examples, training component 530 computes a depth loss based on the ground-truth depth map, where image generation model 520 is trained based on the depth loss.

In some examples, training component 530 obtains additional training data including an occlusion mask. In some examples, training component 530 trains, using the additional training data, image generation model 520 to perform inpainting based on the additional training data. In some aspects, the additional training data includes an additional ground-truth image depicting an alternative view of the ground-truth image, where the occlusion mask is based on the alternative view. In some aspects, the occlusion mask is obtained by applying noise to pixels of the ground-truth image.

FIG. 6 shows an example of a guided diffusion architecture 600 according to aspects of the present disclosure. Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, as in pixel diffusion, or to image features generated by an encoder, as in latent diffusion.

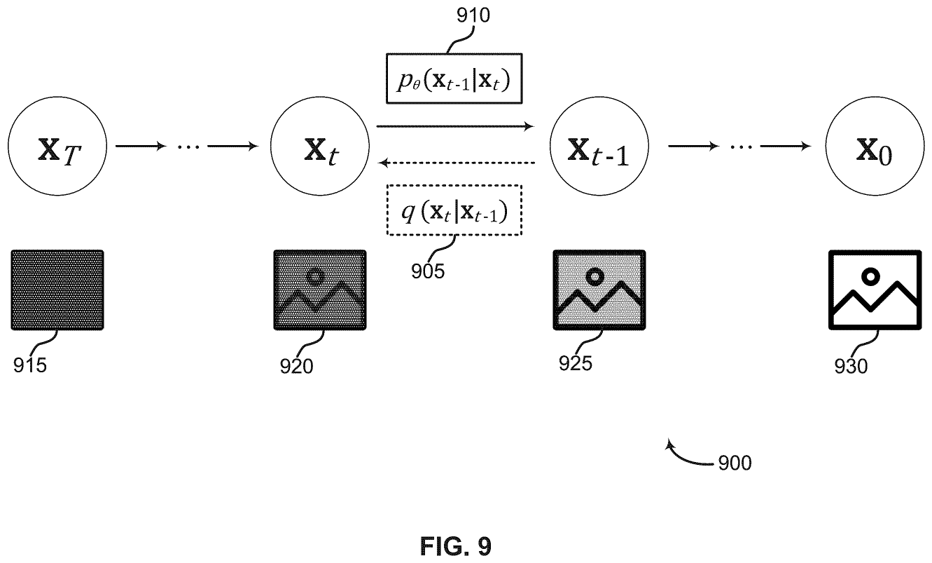

For example, according to some aspects, forward diffusion process 615 gradually adds noise to original image 605 (e.g., an image including color channels corresponding to an image as described herein and a depth channel corresponding to a depth map as described herein) in a masked region in pixel space 610 to obtain noisy images 620 at various noise levels. According to some aspects, reverse diffusion process 625 gradually removes the noise from noisy images 620 at the various noise levels to obtain an output image 630 (e.g., an image including color channels corresponding to an image as described herein and a depth channel corresponding to a depth map as described herein). In some cases, reverse diffusion process 625 is implemented via a U-Net ANN (such as the U-Net architecture described with reference to FIG. 7). In some cases, reverse diffusion process 625 is implemented by the image generation model described with reference to FIGS. 5, 10, and 18. Forward diffusion process 615 and reverse diffusion process 625 are examples of, or include aspects of, the corresponding elements described with reference to FIG. 9.

In some cases, output image 630 is created from each of the various noise levels. According to some aspects, output image 630 is compared to original image 605 to train reverse diffusion process 625 (for example, as described with reference to FIGS. 13-18).

According to some aspects, reverse diffusion process 625 is guided based on a guidance prompt such as text prompt 635, an image prompt, etc. In some cases, text prompt 635 is encoded using encoder 640 (e.g., an encoder as described with reference to FIG. 5) to obtain guidance features 645 (e.g., a guidance embedding) in guidance space 650. In some cases, guidance space 650 is a multimodal embedding space.

According to some aspects, guidance features 645 are combined with noisy images 620 at one or more layers of reverse diffusion process 625 to ensure that output image 630 includes content described by text prompt 635. For example, in some cases, guidance features 645 are combined with noisy images 620 using a cross-attention block within reverse diffusion process 625. In some cases, guidance features 645 are weighted so that guidance features 645 have a greater or lesser representation in output image 630.

Cross-attention, also known as multi-head attention, is an extension of the attention mechanism used in some ANNs for NLP tasks. Cross-attention enables reverse diffusion process 625 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 625 to better understand the context and generate more accurate and contextually relevant outputs.

As shown in FIG. 6, guided diffusion architecture 600 is implemented according to a pixel diffusion model. In some embodiments, guided diffusion architecture 600 is implemented according to a latent diffusion model. In a latent diffusion model, an image encoder first encodes original image 605 as image features in a latent space. Then, forward diffusion process 615 adds noise to the image features, rather than original image 605, to obtain noisy image features. Reverse diffusion process 625 gradually removes noise from the noisy image features (in some cases, guided by guidance features 645) to obtain denoised image features. An image decoder decodes the denoised image features to obtain output image 630 in pixel space 610. In some cases, as a size of image features in a latent space can be significantly smaller than a resolution of an image in a pixel space (e.g., 32, 64, etc. versus 256, 512, etc.), encoding original image 605 to obtain the image features can reduce inference time by a large amount.

FIG. 7 shows an example of a U-Net 700 according to aspects of the present disclosure. According to some aspects, an image generation model (such as the image generation model described with reference to FIG. 5) comprises an ANN architecture known as a U-Net. In some cases, U-Net 700 implements the reverse diffusion process described with reference to FIGS. 6, 9, and 14.

According to some aspects, U-Net 700 receives input features 705, where input features 705 include an initial resolution and an initial number of channels, and processes input features 705 using an initial neural network layer 710 (e.g., a convolutional network layer) to produce intermediate features 715.

A convolution neural network (CNN) is a class of ANN that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that they activate when they detect a particular feature within the input.

In some cases, intermediate features 715 are then down-sampled using a down-sampling layer 720 such that down-sampled features 725 have a resolution less than the initial resolution and a number of channels greater than the initial number of channels.

In some cases, this process is repeated multiple times, and then the process is reversed. For example, down-sampled features 725 are up-sampled using up-sampling process 730 to obtain up-sampled features 735. In some cases, up-sampled features 735 are combined with intermediate features 715 having a same resolution and number of channels via skip connection 740. In some cases, the combination of intermediate features 715 and up-sampled features 735 are processed using final neural network layer 745 to produce output features 750. In some cases, output features 750 have the same resolution as the initial resolution and the same number of channels as the initial number of channels.

According to some aspects, U-Net 700 receives additional input features to produce a conditionally generated output. In some cases, the additional input features include a vector representation of an input prompt. In some cases, the additional input features are combined with intermediate features 715 within U-Net 700 at one or more layers. For example, in some cases, a cross-attention module is used to combine the additional input features and intermediate features 715.

### Image Generation

A method for image generation using machine learning is described with reference to FIGS. 8-12. One or more aspects of the method include receiving a prompt; encoding, using an encoder, the prompt to obtain a guidance embedding; and generating, using an image generation model, an image and a depth map corresponding to the image based on the guidance embedding. In some aspects, the prompt comprises a text prompt.

Some examples of the method further include identifying an occlusion area for a modified view of the image based on the image and the depth map. Some examples further include generating, using the image generation model, a modified image by inpainting the occlusion area. Some examples of the method further include computing a camera view of the image. Some examples further include shifting the camera view to obtain the modified view. Some examples of the method further include generating a video file based on the image and the modified image.

Some examples of the method further include generating, using the image generation model, an additional modified image based on the modified image. Some examples of the method further include averaging pixel information of the image and the modified image to obtain average pixel information, wherein the additional modified image is based on the average pixel information.

FIG. 8 shows an example of a method 800 for generating an image and a depth map according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 8, according to some aspects, an image generation system uses an image generation model to generate an image and a depth map based on a prompt. An example of a conventional image generation system uses an unconditional machine learning model to generate RGB and depth information for an image. However, because the conventional image generation system relies on an unconditional machine learning model, the conventional image generation system is unable to generate an image based on a specific input (e.g., a prompt). By contrast, the image generation model according to some aspects of the present disclosure is able to generate a user-specified image and depth map.

At operation 805, the system receives a prompt. In some cases, the operations of this step refer to, or may be performed by, an image generation apparatus as described with reference to FIGS. 1 and 5. In some cases, a user (such as the user described with reference to FIG. 1) provides the prompt to the image generation apparatus via a user device (such as the user device described with reference to FIG. 1). In some cases, the user provides the prompt via a user interface provided by the image generation apparatus. In some cases, the prompt describes content of an image to be generated by the image generation apparatus. In some cases, the prompt includes a text prompt. In some cases, the prompt includes information in a non-text modality (such as an image modality).

At operation 810, the system encodes the prompt to obtain a guidance embedding. In some cases, the operations of this step refer to, or may be performed by, an encoder as described with reference to FIG. 5.

At operation 815, the system generates, using an image generation model, an image and a depth map corresponding to the image based on the guidance embedding. In some cases, the operations of this step refer to, or may be performed by, an image generation model as described with reference to FIGS. 5, 10, and 18. For example, in some cases, the image generation apparatus generates a noisy image using a forward diffusion process as described with reference to FIGS. 9 and 10.

In some cases, the image generation model generates the image and the depth map by removing noise from the noisy image using a reverse diffusion process guided by the prompt as described with reference to FIGS. 9 and 10. In some cases, the image comprises color information. In some cases, the image comprises one or more channels for the color information. In some cases, the depth map comprises depth information for the image. In some cases, the depth map comprises an image channel of the image.

According to some aspects, the image generation model predicts the image and the depth map simultaneously. For example, in some cases, a last layer in the image generation model comprises a set of image channels for color information and an image channel for depth information. In some cases, because the image generation model learns the color information and the depth information together, there is an implicit interaction and affection between the color information and the depth information, thereby encouraging a consistency between the color information and the depth information such that the image and the depth map describe a same scene and are spatially pixel aligned.

According to some aspects, the image generation system generates a modified image by inpainting an occlusion area of a modified view of the image as described with reference to FIGS. 11-12. In some cases, the image generation apparatus generates a video file based on the image and the modified image. For example, in some cases, the video file includes the image as a first frame of a video and the modified image as a second frame of the video.

FIG. 9 shows an example 900 of diffusion processes according to aspects of the present disclosure. The example shown includes forward diffusion process 905 (such as the forward diffusion process described with reference to FIG. 6) and reverse diffusion process 910 (such as the reverse diffusion process described with reference to FIG. 6). In some cases, forward diffusion process 905 adds noise to an image (or image features in a latent space). In some cases, reverse diffusion process 910 denoises the image (or image features in the latent space) to obtain a denoised image.

According to some aspects, an image generation apparatus (such as the image generation apparatus described with reference to FIGS. 1 and 5) uses forward diffusion process 905 to iteratively add Gaussian noise to an input at each diffusion step t according to a known variance schedule 0<β₁<β₂< . . . <β_{T}><1:

$$q ( {x}_{t} \vert {x}_{t - 1} ) = 𝒩 ( {x}_{t} ; \sqrt{1 - {β}_{t}} {x}_{t - 1} , {β}_{t} I ) \qquad ( 1 )$$

According to some aspects, the Gaussian noise is drawn from a Gaussian distribution with mean μₜ=\sqrt{1−Bₜxₜ₋₁} and variance σ²=βₜ≥1 by sampling ∈˜ [symbol] (0, I) and setting xₜ=\sqrt{1−βₜxₜ₋₁}+\sqrt{βₜ∈}. Accordingly, beginning with an initial input x₀, forward diffusion process 905 produces x₁, . . . , xₜ, . . . . x_{T}, where x_{T} is pure Gaussian noise.

In some cases, an observed variable x₀ (such as original image 930, where original image 930 includes color channels corresponding to an image as described herein and a depth channel corresponding to a depth map as described herein) is mapped in either a pixel space or a latent space to intermediate variables x₁, . . . , x_{T} using a Markov chain, where the intermediate variables x₁, . . . , x_{T} have a same dimensionality as the observed variable x₀. In some cases, the Markov chain gradually adds Gaussian noise to the observed variable x₀ or to the intermediate variables x₁, . . . , x_{T}, respectively, to obtain an approximate posterior q(x_{1:T}|x₀).

According to some aspects, during reverse diffusion process 910, an image generation model (such as the image generation model described with reference to FIGS. 5, 10, and 18) gradually removes noise from X_{T} to obtain a prediction of the observed variable x₀ (e.g., a representation of what the image generation model thinks the original image 930 should be, in terms of both color information and depth information). In some cases, the prediction is influenced by a guidance prompt or a guidance vector (for example, a prompt or a prompt encoding described with reference to FIG. 6). A conditional distribution p(xₜ₋₁|xₜ) of the observed variable x₀ is unknown to the image generation model, however, as calculating the conditional distribution would require a knowledge of a distribution of all possible images. Accordingly, the image generation model is trained to approximate (e.g., learn) a conditional probability distribution p_{θ}(xₜ₋₁|xₜ) of the conditional distribution p(xₜ₋₁ |xₜ):

$${p}_{θ} ( {x}_{t - 1} \vert {x}_{t} ) = 𝒩 ( {x}_{t - 1} ; {μ}_{θ} ( {x}_{t} , t ) , {\sum }_{θ} ( {x}_{t} , t ) ) \qquad ( 2 )$$

In some cases, a mean of the conditional probability distribution p_{θ}(xₜ₋₁ |xₜ) is parameterized by μ_{θ} and a variance of the conditional probability distribution p_{θ}(x_{t -1}|xₜ) is parameterized by Σ_{θ}. In some cases, the mean and the variance are conditioned on a noise level t (e.g., an amount of noise corresponding to a diffusion step t). According to some aspects, the image generation model is trained to learn the mean and/or the variance.

According to some aspects, the image generation model initiates reverse diffusion process 910 with noisy data x_{T} (such as noisy image 915). According to some aspects, the diffusion model iteratively denoises the noisy data x_{T} to obtain the conditional probability distribution p_{θ}(xₜ₋₁ |xₜ). For example, in some cases, at each step t−1 of reverse diffusion process 910, the diffusion model takes xₜ (such as first intermediate image 920) and t as input, where t represents a step in a sequence of transitions associated with different noise levels, and iteratively outputs a prediction of xₜ−1 (such as second intermediate image 925) until the noisy data X_{T} is reverted to a prediction of the observed variable x₀ (e.g., a predicted image for original image 930).

According to some aspects, a joint probability of a sequence of samples in the Markov chain is determined as a product of conditionals and a marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 3 )$$

In some cases, p(x_{T})= [symbol] (x_{T}; 0, I) is a pure noise distribution, as reverse diffusion process 910 takes an outcome of forward diffusion process 905 (e.g., a sample of pure noise X_{T}) as input, and IIₜ₌₁^{T}p_{θ}(xₜ₋₁|xₜ) represents a sequence of Gaussian transitions corresponding to a sequence of addition of Gaussian noise to a sample.

FIG. 10 shows an example of generating an image and a depth map according to aspects of the present disclosure. The example shown includes image generation system 1000, prompt 1005, image generation model 1010, noisy image 1015, noisy depth map 1020, image 1025, and depth map 1030.

Image generation system 1000 is an example of, or includes aspects of, the corresponding element described with reference to FIGS. 1 and 18. Image generation model 1010 is an example of, or includes aspects of, the corresponding element described with reference to FIGS. 5 and 18. Image 1025 is an example of, or includes aspects of, the corresponding element described with reference to FIGS. 3-4, 12, and 18. Depth map 1030 is an example of, or includes aspects of, the corresponding element described with reference to FIGS. 3-4, 12, and 18.

Referring to FIG. 10, according to some aspects, image generation system 1000 generates noisy image 1015 and noisy depth map 1020 using a forward diffusion process (such as the forward diffusion process described with reference to FIG. 9). According to some aspects, image generation model 1010 removes noise from noisy image 1015 and noisy depth map 1020 using a reverse diffusion process (such as the reverse diffusion process described with reference to FIG. 9) guided by prompt 1005 to obtain image 1025 and depth map 1030. In some cases, while depth map 1030 is illustrated as a separate image from image 1025 for the sake of illustration and explanation, depth map 1030 is also a channel of depth information for image 1025, and image 1025 is an illustration of RGB information for image 1025.

FIG. 11 shows an example of a method 1100 for generating a modified image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, according to some aspects, an image generation model (such as the image generation model described with reference to FIGS. 5, 10, and 18) inpaints an occlusion area to obtain a modified image that realistically depicts a shifted camera view from an image (such as an image generated as described with reference to FIGS. 8-11), where a realism and three-dimensional consistency of an object depicted in both the image and the modified image is increased by using the depth map as input in the image generation model.

By contrast, an example of a conventional image generation system uses a first unconditional machine learning model to generate RGB and depth information for a first image, and then uses a second machine learning model to inpaint the RGB and depth information to generate a second image. According to some aspects, by generating the image and modified image, the depth map and modified depth map, or a combination thereof using a same image generation model, the image generation system avoids the time and expense of using two separate machine learning models.

At operation 1105, the system identifies an occlusion area for a modified view of the image based on the image and the depth map. In some cases, the operations of this step refer to, or may be performed by, an occlusion component as described with reference to FIG. 5.

For example, in some cases, an occlusion component identifies an image occlusion area for a modified view of the image. In some cases, an occlusion component identifies a depth occlusion area for a modified view of the depth mask. In some cases, the occlusion component computes a camera view of the image. In some cases, the occlusion component computes a camera view of the depth map. In some cases, the occlusion component shifts the camera view to obtain the modified view.

For example, in some cases, the occlusion component converts each pixel coordinate of the image and the depth map into a three-dimensional point in a camera coordinate system. In some cases, the occlusion component converts the image and the depth map into respective three-dimensional triangular meshes, where a pixel of the image and the depth map respectively correspond to a vertex of the meshes. In some cases, the occlusion component uses the three-dimensional triangular meshes to render the modified view.

In some cases, a user provides a direction for the shift for the camera view (for example, via a user input to a user interface provided by the image generation system). In some cases, each of the image occlusion area and the depth occlusion area comprise one or more pixels that the occlusion component determines are visible in the modified view and are occluded in the camera view. An example of an occlusion area and a modified view are described in further detail with reference to FIG. 12.

At operation 1110, the system generates, using the image generation model, a modified image by inpainting the occlusion area. In some cases, the operations of this step refer to, or may be performed by, an occlusion component as described with reference to FIG. 5.

For example, in some cases, the image generation apparatus adds noise to the image occlusion area and to the depth occlusion area using a forward diffusion process (such as the forward diffusion process described with reference to FIG. 9). In some cases, the image generation model removes the noise from the image occlusion area and the depth occlusion area using a reverse diffusion process (such as the reverse diffusion process described with reference to FIG. 9) to obtain the modified image and the modified depth map. In some cases, the reverse diffusion process is guided by the prompt. Examples of a modified image and a modified depth map are described in further detail with reference to FIG. 12.

In some cases, the image generation apparatus similarly generates an additional modified image and an additional modified depth map for the additional modified image based on the modified image and the modified depth map using the image generation model. In some cases, the image generation model averages pixel information of the image and the modified image to obtain average pixel information, where the additional modified image and the additional modified image are based on the average pixel information. In some cases, by generating the additional modified image based on the average pixel information, a burden of inpainting the additional modified image is reduced and a consistency between the modified image and the additional modified image is increased.

In some cases, the image generation apparatus includes the additional modified image in the video described with reference to FIG. 8.

FIG. 12 shows an example 1200 of generating a modified image according to aspects of the present disclosure. The example shown includes image 1205, depth map 1210, occluded image 1215, image occlusion area 1220, occluded depth map 1225, depth occlusion area 1230, modified image 1235, and modified depth map 1240.

Image 1205 and depth map 1210 are examples of, or include aspects of, the corresponding elements described with reference to FIGS. 3-4, 10, and 18. Modified image 1235 and modified depth map 1240 are examples of, or include aspects of, the corresponding elements described with reference to FIG. 4.

Referring to FIG. 12, an occlusion component identifies image occlusion area 1220 for occluded image 1215 by shifting a camera view of image 1205, and likewise identifies depth occlusion area 1230 for occluded depth map 1225 by shifting a camera view of depth map 1210. In some cases, an image generation system (such as the image generation system described with reference to FIGS. 1, 10, and 18) adds noise to each of image occlusion area 1220 and occluded depth map 1225 using a forward diffusion process (such as the forward diffusion process described with reference to FIG. 9). In some cases, an image generation model (such as the image generation model described with reference to FIGS. 5, 10, and 18) removes noise from each of image occlusion area 1220 and occluded depth map 1225 using a reverse diffusion process (such as the reverse diffusion process described with reference to FIG. 9) to obtain modified image 1235 and modified depth map 1240.

### Training

A method for image generation using machine learning is described with reference to FIGS. 13-18. One or more aspects of the method include initializing an image generation model; obtaining training data including a prompt, a ground-truth image, and a ground-truth depth map; and training, using the training data, the image generation model to generate an image and a depth map based on the prompt. In some aspects, the prompt comprises a text prompt.

Some examples of the method further include computing an image loss based on the ground-truth image, wherein the image generation model is trained based on the image loss. Some examples of the method further include computing a depth loss based on the ground-truth depth map, wherein the image generation model is trained based on the depth loss.

Some examples of the method further include obtaining additional training data including an occlusion mask. In some aspects, the occlusion mask is obtained by applying noise to pixels of the ground-truth image. Some examples further include training, using the additional training data, the image generation model to perform inpainting based on the additional training data. In some aspects, the additional training data includes an additional ground-truth image depicting an alternative view of the ground-truth image, wherein the occlusion mask is based on the alternative view.

FIG. 13 shows an example of a method 1300 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 13, an image generation model of an image generation system is trained to generate an image and a depth map based on a prompt. An example of a conventional image generation systems trains an unconditional machine learning model to generate RGB and depth information for an image. However, because the conventional image generation system relies on an unconditional machine learning model, the conventional image generation system is unable to generate an image based on a specific input (e.g., a prompt). By contrast, because the image generation system according to some aspects of the present disclosure is trained based on a training prompt to generate an image and a depth map based on a prompt, the image generation system is able to provide a user-specified image and depth map for the image.

At operation 1305, the system initializes an image generation model. In some cases, the operations of this step refer to, or may be performed by, a training component as described with reference to FIG. 5. For example, in some cases, the training component randomly initializes weights of the image generation model according to a Gaussian distribution. In some cases, the weights of the image generation model are inherited from a pre-trained image generation model.

At operation 1310, the system obtains training data including a prompt, a ground-truth image, and a ground-truth depth map. In some cases, the operations of this step refer to, or may be performed by, a training component as described with reference to FIG. 5. For example, in some cases, the training component retrieves the training data from a database, such as the database described with reference to FIG. 1. In some cases, the prompt describes content included in the ground-truth image. In some cases, the prompt includes a text prompt. In some cases, the ground-truth depth map includes depth information for the ground-truth image. In some cases, the ground-truth image is an image as described herein. In some cases, the ground-truth depth map is a depth map as described herein.

At operation 1315, the system trains, using the training data, the image generation model to generate an image and a depth map based on the prompt. In some cases, the operations of this step refer to, or may be performed by, a training component as described with reference to FIG. 5.

In some cases, the training component computes an image loss based on the ground-truth image. For example, in some cases, the image generation model generates an image based on the prompt, and the training component compares the image to the ground-truth image to compute the image loss.

A loss function refers to a function that impacts how a machine learning model is trained in a supervised learning model. For example, during each training iteration, the output of the machine learning model is compared to the known annotation information in the training data. The loss function provides a value (the “loss”) for how close the predicted annotation data is to the actual annotation data. After computing the loss, the parameters of the model are updated accordingly and a new set of predictions are made during the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). In some cases, a supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

In some cases, the training component updates the parameters of the image generation model according to the image loss. For example, in some cases, the training component optimizes the parameters of the image generation model for a negative log likelihood according to the image loss.

In some cases, the training component computes a depth loss based on the ground-truth image. For example, in some cases, the image generation model generates a depth map based on the prompt, and the training component compares the image to the ground-truth depth map to compute the depth loss. In some cases, the training component updates the parameters of the image generation model according to the depth loss. For example, in some cases, the training component optimizes the parameters of the image generation model for a negative log likelihood according to the depth loss.

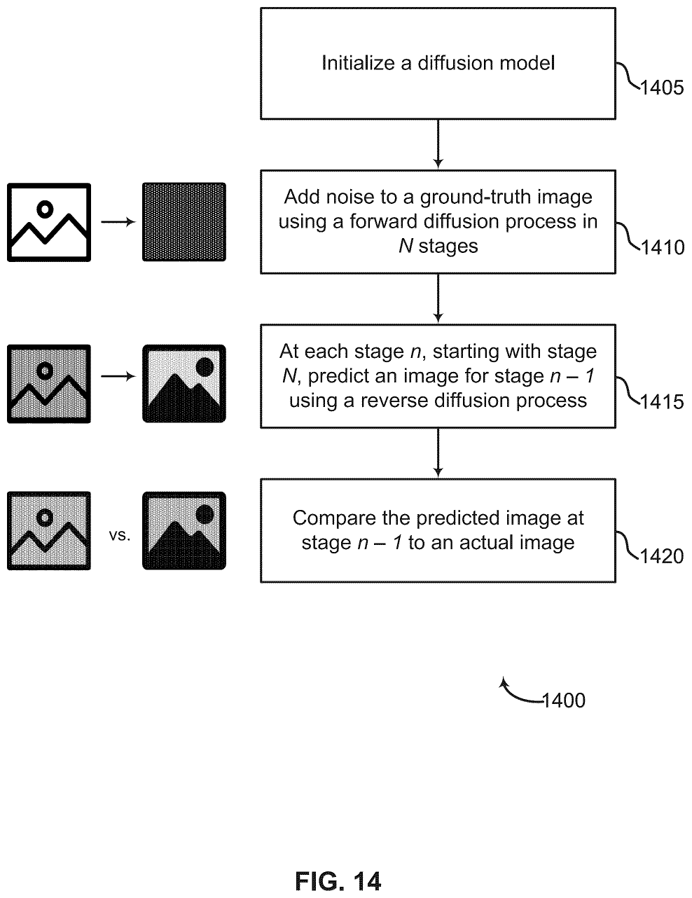

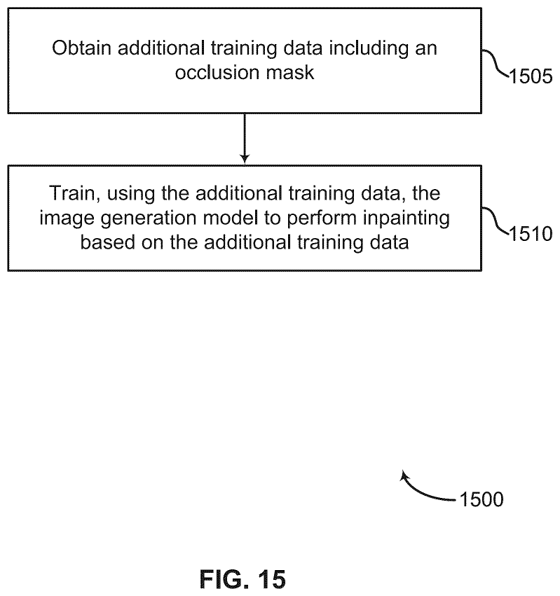

According to some aspects, the image generation model includes a diffusion model, and the training component trains the image generation model as described with reference to FIG. 14. According to some aspects, the training component trains the image generation model to perform inpainting to obtain a modified image as described with reference to FIGS. 15-18.

FIG. 14 shows an example of a method 1400 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 14, according to some aspects, a training component (such as the training component described with reference to FIG. 5) trains an image generation model (such as the image generation model described with reference to FIGS. 5, 10, and 18) including a diffusion model to generate an image and a depth map based on a prompt.

At operation 1405, the system initializes the image generation model. In some cases, the operations of this step refer to, or may be performed by, a training component as described with reference to FIG. 5. In some cases, the initialization includes defining the architecture of the image generation model and establishing initial values for parameters of the image generation model. In some cases, the training component initializes the image generation model to implement a U-Net architecture (such as the U-Net architecture described with reference to FIG. 7). In some cases, the initialization includes defining hyperparameters of the architecture of the image generation model, such as a number of layers, a resolution and channels of each layer block, a location of skip connections, and the like. In some cases, the training component randomly initializes weights of the image generation model according to a Gaussian distribution. In some cases, the weights of the image generation model are inherited from a pre-trained image generation model.

At operation 1410, the system adds noise to a training image using a forward diffusion process (such as the forward diffusion process described with reference to FIGS. 6 and 9) in N stages. In some cases, the operations of this step refer to, or may be performed by, a training component as described with reference to FIG. 5. In some cases, the training component retrieves the training image from a database (such as the database described with reference to FIG. 1). In some cases, the training image includes the ground-truth image and the ground-truth depth map described with reference to FIG. 13. In some cases, the ground-truth image includes color information for the training image. In some cases, the ground-truth depth map includes depth information for the training image.

At operation 1415, at each stage n, starting with stage N, the system predicts an image (such as an image including RGB information and a depth map including depth information) for stage n−1 using a reverse diffusion process. In some cases, the operations of this step refer to, or may be performed by, the image generation model. According to some aspects, the image generation model performs the reverse diffusion process as described with reference to FIGS. 6 and 9, where each stage n corresponds to a diffusion step t, to predict noise that was added by the forward diffusion process. In some cases, at each stage, the image generation model predicts noise that can be removed from an intermediate image (including an image and a depth map as described herein) to obtain a predicted image. In some cases, an intermediate image is predicted at each stage of the training process.

In some cases, the reverse diffusion process is conditioned on the prompt. In some cases, an encoder (such as the encoder described with reference to FIGS. 5-6) retrieves the prompt and generates the guidance features in a guidance space. In some cases, at each stage, the image generation model predicts noise that can be removed from an intermediate image to obtain a predicted image (including an image and a depth map as described herein) that aligns with the guidance features.

At operation 1420, the system compares the predicted image at stage n−1 to an actual image, such as the image at stage n−1 or the original input image (e.g., the training image). In some cases, the operations of this step refer to, or may be performed by, a training component as described with reference to FIG. 5. In some cases, the training component computes a loss function based on the comparison (such as one or more of the image loss and the depth loss described with reference to FIG. 13).

At operation 1425, the system updates parameters of the image generation model based on the comparison. In some cases, the operations of this step refer to, or may be performed by, a training component as described with reference to FIG. 5. In some cases, the training component updates the image generation parameters of the image generation model based on one or more loss functions (such as the image loss and the depth loss described with reference to FIG. 13). For example, in some cases, the training component updates parameters of the U-Net using gradient descent. In some cases, the training component trains the U-Net to learn time-dependent parameters of the Gaussian transitions. In some cases, the training component optimizes for a negative log likelihood. In some cases, the training component fine-tunes weights of the image generation model until convergence.

FIG. 15 shows an example of a method 1500 for training an image generation model to perform inpainting according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 15, according to some aspects, the training component trains the image generation model to perform inpainting based on an occlusion mask. In some cases, the modified image realistically depicts a shifted camera view from an image that the image generation model is trained to generate as described with reference to FIGS. 13-14, where a realism and a three-dimensional consistency of an object depicted in both the image and the modified image is increased by training the image generation model to perform both image generation and image inpainting.

By contrast, an example of a conventional image generation system trains a first unconditional machine learning model to generate RGB and depth information for a first image, and then trains a separate, second machine learning model using separate training data to perform inpainting on the RGB and depth information to generate a second image. Because the conventional image generation system trains two separate image generation and image inpainting models using separate data, the conventional image generation system achieves less consistent image inpainting results than image generation systems according to aspects of the present disclosure.

At operation 1505, the system obtains additional training data including an occlusion mask. In some cases, the operations of this step refer to, or may be performed by, a training component as described with reference to FIG. 5. As used herein, an “occlusion mask” refers to a pixel mask. In some cases, the training component retrieves the additional training data from a database (such as the database described with reference to FIG. 1).

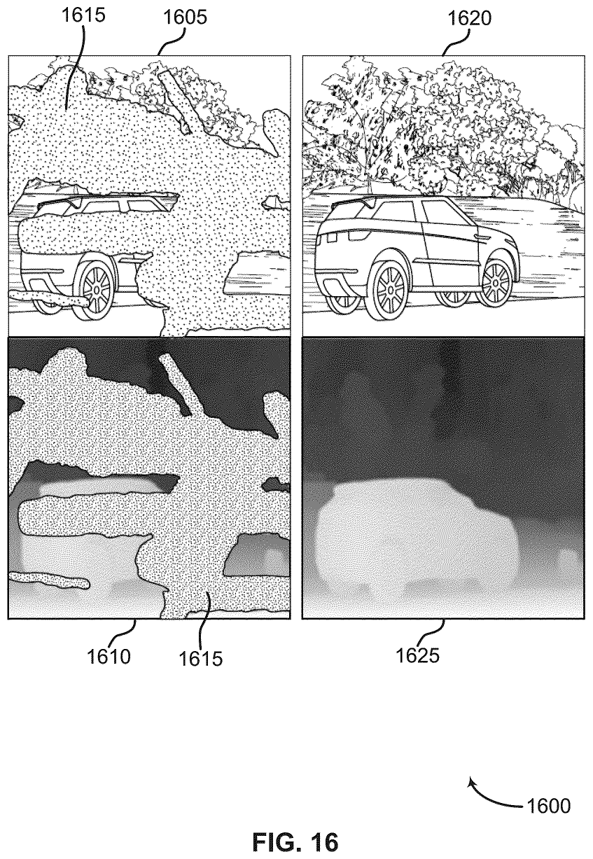

According to some aspects, the training component generates the occlusion mask by applying a mask to randomly selected pixels of a ground-truth image (such as the ground-truth image described with reference to FIGS. 13-14) and a ground-truth depth map (such as the ground-truth depth map described with reference to FIGS. 13-14). An example of an occlusion mask obtained by applying a mask to random pixels of a ground-truth image and a ground-truth depth map is described with reference to FIG. 16.

In some cases, the additional training data includes an additional ground-truth image depicting an alternative view of the ground-truth image, where the occlusion mask is based on the alternative view. In some cases, the additional training data includes an additional ground-truth depth map depicting an alternative view of the ground-truth depth map, where the occlusion mask is based on the alternative view.

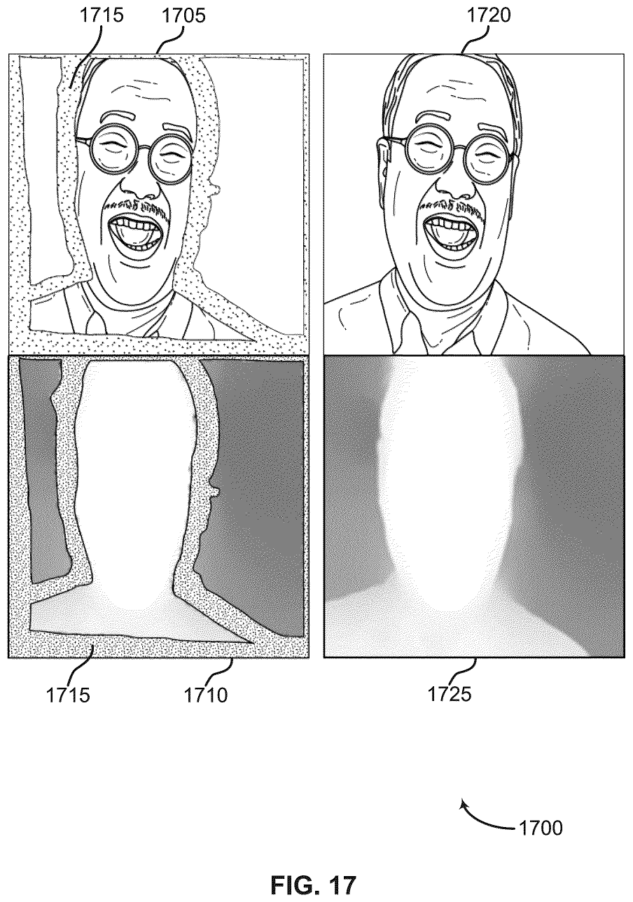

For example, in some cases, an occlusion component (such as the occlusion component described with reference to FIG. 5) shifts a camera view from the ground-truth image to obtain the alternative view as described with reference to FIGS. 11-12, where the additional ground-truth image depicts the alternative view of the ground-truth image, and where the “missing” pixels of the additional ground-truth image comprise the occlusion mask. According to some aspects, the occlusion component applies the occlusion mask to pixels of the ground-truth image. An example of an occlusion mask obtained by shifting a camera view of a ground-truth image is described with reference to FIG. 17.

At operation 1510, the system trains, using the additional training data, the image generation model to perform inpainting based on the additional training data. In some cases, the operations of this step refer to, or may be performed by, a training component as described with reference to FIG. 5.

For example, in some cases, the training component provides an occluded ground-truth image and an occluded ground-truth depth map respectively including the occlusion mask to the image generation model as an additional input during the training process described with reference to FIGS. 13-14, such that the image generation model generates the image and the depth map based on a combination of the prompt, the ground-truth image, the occluded ground-truth image, the ground-truth depth map, and the occluded ground-truth depth map.

For example, in some cases, during the training process described with reference to FIG. 14, the training component also adds noise to the occlusion mask of the occluded ground-truth image and the occluded ground-truth depth map and removes noise from the occlusion mask according to the prompt to obtain the image and the depth map.

In some cases, during one or more time steps of the training process (e.g., half of the time steps), the training component adds noise to each pixel of the occluded ground-truth image and the occluded ground-truth depth map, and the image generation model makes a noise removal prediction for each pixel of the occluded ground-truth image and the occluded ground-truth depth map.

In some cases, the training component uses an occlusion mask obtained by applying a mask to random pixels as described with reference to FIGS. 13 and 16 during some time steps of the training process, and uses an occlusion mask obtained by shifting a camera view as described with reference to FIGS. 13 and 17 during other time steps of the training process.

According to some aspects, the training component trains the image generation model to generate the image and the depth map based on the prompt as described with reference to FIGS. 13-14 during a first training stage. According to some aspects, the training component trains the image generation model to perform inpainting based on the occlusion mask during a second training stage following the first training stage. An example of training an image generation model to perform inpainting is described with reference to FIG. 18.

FIG. 16 shows an example 1600 of an occlusion mask obtained by applying a mask to random pixels of a ground-truth image according to aspects of the present disclosure. The example shown includes occluded ground-truth image 1605, occluded ground-truth depth map 1610, occlusion mask 1615, ground-truth image 1620, and ground-truth depth map 1625. Occluded ground-truth image 1605 and occluded ground-truth depth map 1610 are examples of, or include aspects of, the corresponding elements described with reference to FIGS. 17-18. Occlusion mask 1615 is an example of, or includes aspects of, the corresponding element described with reference to FIG. 17.

Referring to FIG. 16, according to some aspects, a training component (such as the training component described with reference to FIG. 5) obtains occlusion mask 1615 for occluded ground-truth image 1605 and occluded ground-truth depth map 1610 by applying a mask to randomly selected pixels of ground-truth image 1620 and ground-truth depth map 1625. As shown in FIG. 16, the training component has added noise to pixels of occlusion mask 1615 using a forward diffusion process as described with reference to FIG. 15.

FIG. 17 shows an example of an occlusion mask obtained by shifting a camera view of a ground-truth image according to aspects of the present disclosure. The example shown includes occluded ground-truth image 1705, occluded ground-truth depth map 1710, occlusion mask 1715, ground-truth image 1720, and ground-truth depth map 1725. Occluded ground-truth image 1705 and occluded ground-truth depth map 1710 are examples of, or include aspects of, the corresponding elements described with reference to FIGS. 16 and 18. Occlusion mask 1715 is an example of, or includes aspects of, the corresponding element described with reference to FIG. 16.

Referring to FIG. 17, according to some aspects, an occlusion component (such as the occlusion component described with reference to FIG. 5) obtains occlusion mask 1715 by shifting a camera view to obtain occluded pixels as described with reference to FIG. 15. In some cases, occlusion mask 1715 comprises the occluded pixels. In some cases, the training component respectively applies occlusion mask 1715 to ground-truth image 1720 and ground-truth depth map 1725 to obtain occluded ground-truth image 1705 and occluded ground-truth depth map 1710. As shown in FIG. 17, the training component has added noise to pixels of occlusion mask 1715 using a forward diffusion process as described with reference to FIG. 15.

FIG. 18 shows an example of training an image generation model to perform inpainting according to aspects of the present disclosure. The example shown includes image generation system 1800, prompt 1805, image generation model 1810, noisy ground-truth image 1815, noisy ground-truth depth map 1820, occluded ground-truth image 1825, occluded ground-truth depth map 1830, image 1835, and depth map 1840.

Image generation system 1800 is an example of, or includes aspects of, the corresponding element described with reference to FIGS. 1 and 10. Prompt 1805 is an example of, or includes aspects of, the corresponding element described with reference to FIG. 10. Image generation model 1810 is an example of, or includes aspects of, the corresponding element described with reference to FIGS. 5 and 10. Occluded ground-truth image 1825 and occluded ground-truth depth map 1830 are examples of, or include aspects of, the corresponding elements described with reference to FIGS. 16-17. Image 1835 and depth map 1840 are examples of, or include aspects of, the corresponding elements described with reference to FIGS. 3-4 and 10, and 12.

Referring to FIG. 18, according to some aspects, image generation model 1810 is trained to generate image 1835 and depth map 1840 based on prompt 1805, noisy ground-truth image 1815, noisy ground-truth depth map 1820, occluded ground-truth image 1825, and occluded ground-truth depth map 1830.

For example, in some cases, a training component (such as the training component described with reference to FIG. 5) adds noise to a ground-truth image and a ground-truth depth map using a forward diffusion process (such as the forward diffusion process described with reference to FIG. 14) to respectively obtain noisy ground-truth image 1815 and noisy ground-truth depth map 1820 and adds noise to an occlusion mask to obtain occluded ground-truth image 1825 and occluded ground-truth depth map 1830.

In some cases, image generation model 1810 removes noise from noisy ground-truth image 1815, noisy ground-truth depth map 1820, occluded ground-truth image 1825, and occluded ground-truth depth map 1830 to obtain image 1835 and depth map 1840. In some cases, the training component compares image 1835 with the ground-truth image and updates image generation model 1810 based on the comparison as described with reference to FIGS. 13-14. In some cases, the training component compares depth map 1840 with the ground-truth depth map and updates image generation model 1810 based on the comparison as described with reference to FIGS. 13-14.

FIG. 19 shows an example of a computing device 1900 for multi-modal image editing according to aspects of the present disclosure. In one aspect, computing device 1900 includes processor(s) 1905, memory subsystem 1910, communication interface 1915, I/O interface 1920, user interface component(s) 1925, and channel 1930.

In some embodiments, computing device 1900 is an example of, or includes aspects of, the image generation apparatus described with reference to FIGS. 1 and 5. In some embodiments, computing device 1900 includes one or more processors 1905 that can execute instructions stored in memory subsystem 1910 to receive a prompt; encode, using an encoder, the prompt to obtain a guidance embedding; and generate, using an image generation model, an image and a depth map corresponding to the image based on the guidance embedding.

According to some aspects, computing device 1900 includes one or more processors 1905. Processor(s) 1905 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1910 includes one or more memory devices. Memory subsystem 1910 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or via hardware components controlled by the I/O controller.

According to some aspects, user interface component(s) 1925 enable a user to interact with computing device 1900. In some cases, user interface component(s) 1925 include an audio device, such as an external speaker system, an external display device such as a display screen, an input device (e.g., a remote control device interfaced with a user interface directly or through the I/O controller), or a combination thereof. In some cases, user interface component(s) 1925 include a GUI.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
receiving a prompt;
encoding, using an encoder of a machine learning model, the prompt to obtain a guidance embedding; and
generating, using an image generation model of the machine learning model, an image and a depth map corresponding to the image, wherein the image and the depth map are each generated based on the guidance embedding.

2. The method of claim 1, further comprising:
identifying an occlusion area for a modified view of the image based on the image and the depth map; and
generating, using the image generation model, a modified image corresponding to the modified view by inpainting the occlusion area.

3. The method of claim 2, wherein identifying the occlusion area comprises:
computing a camera view of the image; and
shifting the camera view to obtain the modified view.

4. The method of claim 2, further comprising:
generating, using the image generation model, an additional modified image based on the modified image.

5. The method of claim 4, wherein generating the additional modified images comprises:
averaging pixel information of the image and the modified image to obtain average pixel information, wherein the additional modified image is based on the average pixel information.

6. The method of claim 2, further comprising:
generating a video file based on the image and the modified image.

7. The method of claim 1, wherein:
the prompt comprises a text prompt.

8. A method for image generation, comprising:
initializing an image generation model;
obtaining training data including a prompt, a ground-truth image, and a ground-truth depth map; and
training, using the training data, the image generation model to generate an image and a depth map based on the prompt.

9. The method of claim 8, wherein training the image generation model comprises:
computing an image loss based on the ground-truth image, wherein the image generation model is trained based on the image loss.

10. The method of claim 8, wherein training the image generation model comprises:
computing a depth loss based on the ground-truth depth map, wherein the image generation model is trained based on the depth loss.

11. The method of claim 8, further comprising:
obtaining additional training data including an occlusion mask; and
training, using the additional training data, the image generation model to perform inpainting based on the additional training data.

12. The method of claim 11, wherein:
the additional training data includes an additional ground-truth image depicting an alternative view of the ground-truth image, wherein the occlusion mask is based on the alternative view.

13. The method of claim 11, wherein:
the occlusion mask is obtained by applying noise to pixels of the ground-truth image.

14. The method of claim 8, wherein:
the prompt comprises a text prompt.

15. A system for image generation, comprising:
one or more processors;
one or more memory components coupled with the one or more processors; and
an image generation model comprising parameters stored in the one or more memory components and trained to generate an image and a depth map for the image based on a text prompt.

16. The system of claim 15, the system further comprising:
an occlusion component configured to generate an occlusion area for a modified view of the image based on the image and the depth map.

17. The system of claim 16, wherein:
the image generation model is further trained to generate a modified image by inpainting the occlusion area.

18. The system of claim 15, the system further comprising:
an encoder configured to generate a guidance embedding based on the prompt.

19. The system of claim 15, the system further comprising:
a training component configured to train the image generation model.

20. The system of claim 15, wherein:
the image generation model comprises a diffusion model.
